(19) United States
(12) Patent Application Publication
(10) Pub. No.: US 2010/0025984 A1
(43) Pub. Date: Feb. 4, 2010

(54) Device for connecting a pipe to an exhaust outlet

(76) Inventors: Wilhelm Kullen, Hulben (DE); Hansjürgen Mattheis, Blaubeuren (DE)

Correspondence Address: Mark S. Bicks;Roylance Abrahams Berdo & Goodman, 1300 19th Street N W, Suite 600, Washington, DC, 20036, US

(21) Appl. No.: 12/309,358

(22) PCT Filed: Jun. 12, 2007
(86) PCT No.: PCT/EP2007/005148

§ 371 Date: Sep. 3, 2009

(30) Foreign Application Priority Data
Jul. 19, 2006 (DE) 10 2006 033 357.8

(51) Int. Cl. F16L 41/08; F16L 39/04; F16L 41/14

(52) U.S. Cl. 285/189

(57) ABSTRACT

A device for forming a sealed screw connection for the connection of a pipe (5) to an outlet (3) for a flow medium thermally loading the device, in particular for the connection of an exhaust manifold (5) to an exhaust gas outlet (3) of an internal combustion engine, with drilled holes provided in a fixing flange (7) of the pipe (5) for appropriate threaded bolts (15), and with a sealing arrangement located between flange (7) and outlet (3), is characterized in that an enclosure part (19) is provided that encloses the flange (7) on the side thereof facing away from the outlet (3), while leaving at least one connecting passage (23) clear for the medium and forming an at least partial opening of the other edge regions of the flange (7) penetrated by the threaded bolts (15). In the enclosure part (19), at least one drilled hole has a diameter matched to the threaded bolt (15) associated with said drilled hole, and the drilled holes located in the flange (7) are constructed as elongated holes which facilitate movement of the pipe (5) in a displacement direction at an angle to the threaded bolts (15), and a sealing element of the sealing arrangement is located on both sides of the part (21) of the enclosure part (19) facing the outlet (3).

The invention relates to a device for forming a sealed screw connection for connecting a pipe to an outlet for a flow medium which thermally loads the device, in particular for connecting an exhaust manifold to the exhaust outlet of an internal combustion engine, with holes provided in a fixing flange of the pipe for the respective threaded bolts and a sealing arrangement located between the flange and the outlet.

Of course, thermal loads as occur in hot flow media, in particular in the exhaust gases of internal combustion engines, can lead to major mutual distortions of the components in line connections with fixed screw connections. Differences in the amount of thermal expansion of the flange of exhaust manifolds relative to the colder cylinder head of a pertinent internal combustion engine can be, for example, in the millimeter range. This leads to a series of adverse effects such as deformation of the manifold, lengthening of the threaded bolts/stud bolts, damage to the bolt thread, damage to the cylinder head, loosening of the seal combination with the corresponding sealing problems, component wear, etc. The increase of the temperature level in the exhaust gas region, which is currently being observed, leads to further exacerbation of these problems.

To remedy this, attempts are currently underway to reduce the mutual adverse effects on the components by reduced tightening torque of the screw connection. As a result of this measure, deformation of the manifold is reduced, at the same time, however, cyclic changes in length of the manifold occur to an intensified degree. This can lead in turn to damage of the threaded bolts as a result of the entraining effect on the screw head or the nut of the threaded bolt due to friction against the flange of the manifold. As a result the threaded bolts can be moved cyclically back and forth, the bolt thread is damaged, the sealing combination is loosened, and leaks occur.

With respect to these problems, the object of the invention is to make available a device which ensures reliable connection of a pipe, in particular an exhaust manifold, even in operating conditions with high thermal loading.

According to the invention, this object is achieved by a device which has the features of claim 1 in its entirety.

According to the characterizing part of claim 1, the invention provides for an enclosure part for the flange of the pipe. While oblong holes, which are located in the flange of the pipe, allow a displacement motion of the flange relative to the threaded bolts, the enclosure part is essentially fixed by a suitable diameter of at least one hole and the associated threaded bolt against thermally induced displacement motions. Accordingly, the threaded bolts, which penetrate the enclosure part, are decoupled from the displacement motions of the flange. Displacement motions of the flange take place on its side facing the outlet relative to the adjoining seal element of the sealing arrangement, which element is also encompassed by the enclosure part, and on the opposite upper side of the flange relative to the inside of the enclosure part and therefore not in frictional contact against the screw head (nut) of the screw connection. Thermally induced movements of the flange therefore do not cause any flexural loads of the threaded bolts. In this respect, it is also possible for the exhaust manifold to move relative to the entire seal or for the exhaust manifold, including associatable seal parts, to be shifted relative to other seal parts.

In advantageous embodiments, the flange on the two longitudinal edges that extend along the displacement direction, which is dictated by the oblong holes, has a sequence of oblong holes, the enclosure part on its side facing the outlet forming a bottom which continues essentially from longitudinal edge to longitudinal edge of the flange, and which is provided with passages for the medium and with holes that are matched to the diameters of the threaded bolts. This yields between the enclosure part and the facing surface of the flange on the bottom of the enclosure part a continuous sealing surface for the sealing element of the sealing arrangement, which element is located on the inside of the bottom of the enclosure part.

In especially advantageous embodiments the enclosure part is made integral with the side walls that are angled off from the bottom and that extend along the longitudinal edges of the flange, and with cover parts which extend in the region of the longitudinal edges of the flange on its upper side which faces away from the outlet. In this cage-like configuration of the enclosure part the installation process is especially simple in the production of a junction, because the enclosure part which surrounds the flange in the form of a cage can be slipped onto the flange beforehand, where it advantageously remains by self-retention in the installation position, in which both the holes in the enclosure part as well as the oblong holes in the flange can be penetrated by the threaded bolts when the junction is produced.

The arrangement can be such that the cover parts, which contain a sequence of holes for the threaded bolts, extend over the entire length of the enclosure part. In such embodiments it can be advantageous in regions, which are located between successive holes, to provide the cover parts with convexities which each form an intermediate space between the upper side of the flange and the cover part. These intermediate spaces, which reduce the size of the contact surface between the flange and the enclosure part, reduce the heat transfer to the enclosure part.

Alternatively, the arrangement can be such that the cover parts are divided into separate cover sections which are separated by intermediate spaces, the holes for the threaded bolts being provided in the cover sections. In this respect as well, heat transfer is reduced by the intermediate spaces present between the cover sections.

As indicated in the foregoing, in the invention relative movement between the flange and enclosure part can take place due to thermal expansion. More precisely, sliding zones are formed between the upper side of the flange and the cover parts of the enclosure part and between the bottom and the facing side of the flange, here displacement taking place on one or both sealing surfaces of the sealing element of the sealing arrangement. In this respect, it can be advantageous to make the sealing element, which is provided between the bottom of the enclosure part and the facing surface of the flange, to be friction-reducing and/or to provide it with friction-reducing means. Furthermore, displacement can also occur between the laminar sealing parts themselves.

Analogously, it is advantageous for there to be friction-reducing configurations and/or friction-reducing means between the upper side of the flange and the cover parts of the enclosure part.

In cases, in which the flange is part of an exhaust manifold which, in order to form a common connection for several exhaust outlets distributed in the longitudinal direction, has elongated longitudinal edges that contain oblong holes and shorter side edges that connect the longitudinal edges on the end side, the enclosure part extends preferably over the entire sequence of oblong holes of the flange. In this configuration it is also possible to decouple the entire screw connection which can have at least one pair of threaded bolts each in a multi-cylinder engine for the exhaust outlet of each cylinder by means of a single enclosure part relative to the displacement motions of the flange.

The invention is detailed below using embodiments shown in the drawings.

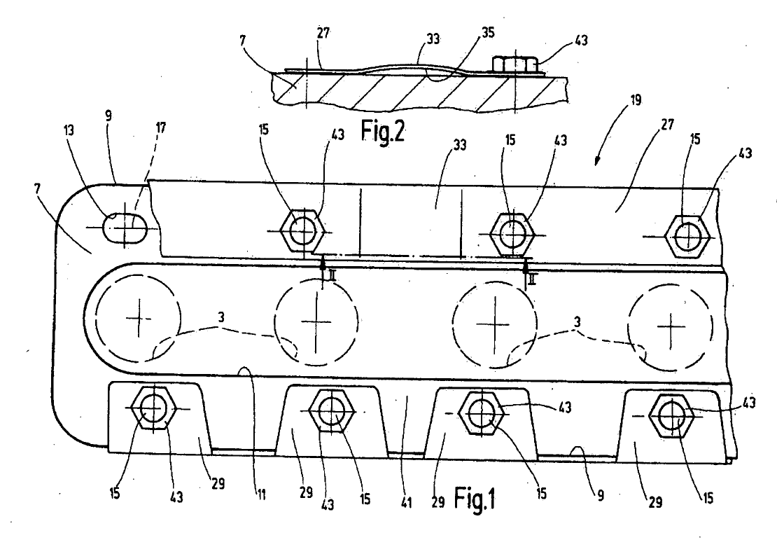

FIG. 1 shows a front view, drawn approximately on natural scale and cutaway and partially cutaway, of an exhaust manifold that is attached by means of a screw connection to the cylinder head of an internal combustion engine, which head is not shown, in the half of the figure which lies at the upper side in the drawing a first embodiment of the device according to the invention and in the lower half of the FIG. 1 a second embodiment of the device according to the invention being illustrated;

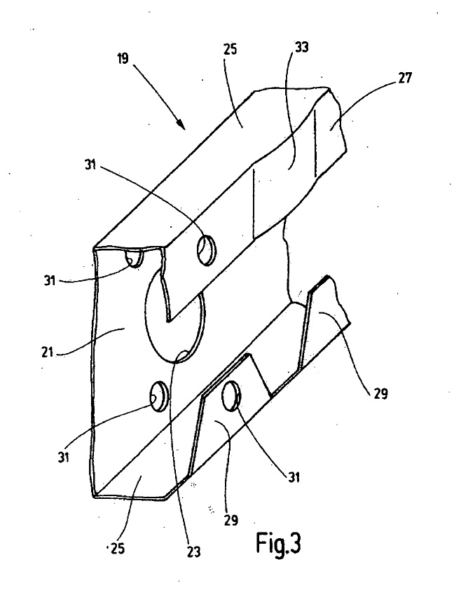

FIG. 2 shows a partial longitudinal section which has been drawn enlarged relative to FIG. 1 according to cutting line II-II from FIG. 1;

FIG. 3 shows a cutaway, perspective oblique view of a longitudinal section of the enclosure part shown in FIG. 1, as in FIG. 1 the first embodiment lying at the upper side in the figure. and the second embodiment lying at the bottom in the figure;

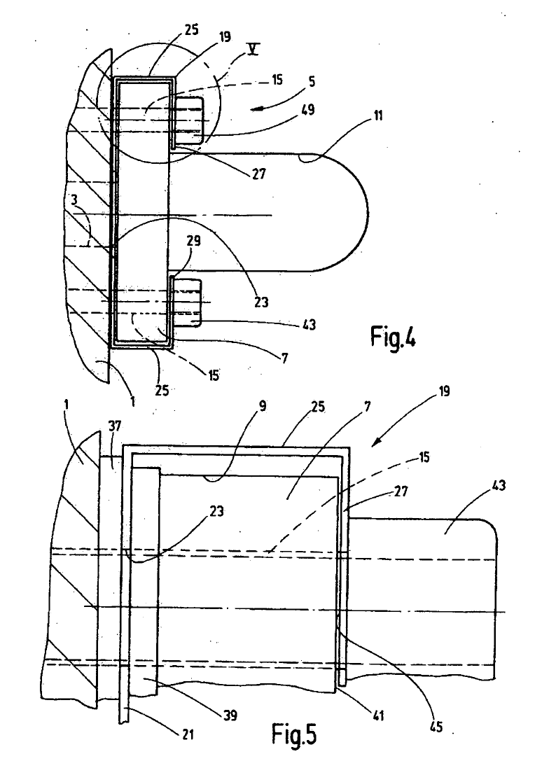

FIG. 4 shows a side view of what is shown in FIG. 1, a partial region of the associated cylinder head being shown in a cutaway section, and FIG. 5 shows an enlarged partial representation of the partial region designated as V in FIG. 4.

The invention is explained below using the example of a screw connection for connecting an exhaust manifold to the cylinder head of a multi-cylinder internal combustion engine. It goes without saying that the invention can be advantageously used equally well in screw connections for connecting different types of pipes through which hot media, which can be gaseous or liquid, flow.

In the drawings, of a multi-cylinder internal combustion engine only FIGS. 4 and 5 shows a cylinder head in certain sections, which is designated as 1. On the cylinder head 1, for the successive cylinders there are exhaust outlets 3 which are offset to one another in the longitudinal direction, of which FIG. 1 shows four exhaust outlets 3. The exhaust manifold which is to be connected to the cylinder head 1 by means of the screw connection according to the invention and which is designated as 5 as a whole in FIG. 4, as can be clearly seen from the latter figure, has a fixing flange 7 of conventional design which surrounds the open end of the exhaust collector 11 (FIG. 4).

Distributed along its elongated longitudinal edges 9, the flange 7 has a sequence of oblong holes 13 through which threaded bolts can extend which can be stud bolts 15 that are anchored in the cylinder head 1 in the embodiment. As FIG. 1 shows, the orientation of the oblong holes 13 for a displacement motion of the flange 7 relative to the stud bolts 15 dictates the direction of displacement toward one axis 17 (FIG. 1) which runs in the longitudinal direction of the longitudinal edges 9. For exact positioning of the components that can be moved toward one another in an initial position, which is initially thermally unloaded, a corresponding reamed hole with engageable fitting pins can be provided.

Of the enclosure part which is designated as a whole as 19 in FIGS. 1, 3 and 5, FIG. 3 shows a partial longitudinal section separately. The enclosure part 19 is shaped in one piece from a steel sheet and has a flat bottom 21 in which there is a sequence of passages 23 (FIGS. 3 and 4) which are aligned with the exhaust outlets 3 on the cylinder head 1 in the installation state shown in FIG. 4. Instead of a flat bottom 21, in an embodiment, which is not shown, the bottom can also be crimped or profiled. As FIG. 3 likewise clearly shows, in the side edges of the bottom 21 which run longitudinally, side walls 25 extend which are angled at a right angle out of its plane and to which in turn angled cover parts 27 are connected. According to the example shown in the upper half of FIGS. 1 and 3, the cover parts 27 can have the shape of continuous cover strips, while in the embodiments shown in the lower half of the figure the cover parts are divided into separate cover sections 29 between which there are gaps. In the bottom 21 and in the cover parts 27, in the latter example in the cover sections 29, there are holes 31 for the stud bolts 15, at least some of the holes 31 provided in the enclosure part 19 being matched in diameter to the diameter of the respective stud bolt 15 so that the enclosure part 19 cannot be moved relative to the stud bolts 15. The indicated cover parts can also be perforated and/or structured.

As can likewise be most clearly seen from FIGS. 3 and 4, the enclosure part 19 has a cage-like shape such that it encloses the flange 7 of the exhaust manifold 5 on its side associated with the cylinder head 1 with its bottom 21, that the side walls 25 extend over the longitudinal edges 9 of the flange 7, and the cover parts 27, optionally in the form of cover sections 29, extend to the upper side 41 of the flange 7. In the embodiment in which separate cover sections 29 located at a distance from one another are provided, heat transfer between the manifold 7 and the enclosure part 19 is reduced by the reduction in the size of the contact surface. In the example shown at the top in FIGS. 1 and 3, with the cover parts 27 in the form of continuous strips, a corresponding reduction of heat transfer can be achieved in that in the sections located between holes 31 a deformation of the cover parts 27 is effected such that convexities 33 are formed which yield intermediate spaces 35 (see FIG. 2) between the cover part 27 and the flange 7.

As is apparent from FIG. 5, in which the dimensions of the sealing elements of the sealing arrangement are shown exaggerated to improve clarity, the sealing arrangement, which is provided for sealing between the manifold 5 and the cylinder head 1, has a first sealing element 37 which adjoins the cylinder head 1 and a second sealing element 39 which adjoins the flange 7. The bottom 21 of the enclosure part 19 extends between the first and second sealing element. Since, as already stated, the enclosure part 19 is protected against thermally induced displacement motions, there are no relative movements on the sealing surfaces of the first sealing element 37. On the other hand, a displacement motion of the flange 7 due to thermal expansion can take place so that relative movement can occur on the sealing surfaces of the second sealing element 39 by either the flange 7 moving relative to the sealing element 39 or the sealing element 39 moving together with the flange 7 relative to the bottom 21 of the enclosure part. In this respect, it can be advantageous to use friction-reducing configurations or materials such as brass, bronze, boron nitrite or the like on the second sealing element 39 and/or on the bottom 21 of the enclosure part 19 and/or on the adjoining surface of the flange 7. Similar measures can be advantageous on the upper side 41 of the flange 7 over which the cover parts 27 or cover section 29 have extended. In an embodiment which is not detailed, the first sealing element 37 would not necessarily have to be present and the passage 23 could also be crimped or could have an enclosure bead.

As is apparent, the screw heads of the screw connection are formed by nuts 43 which sit on the stud bolts. The tightened nuts 43 press on the cover parts 27 or optionally the cover sections 29, that is, on contact surfaces on the enclosure part 19 which does not execute any thermally induced displacement motions. In displacements of the flange 7 there is therefore no frictionally induced entrainment of the nuts 43, as would be the case if the nuts 43 were supported on the flange 7. Rather, relative movement takes place on the upper side 41 of the flange in a displacement zone 45 (FIG. 5) relative to the respective cover part 27/cover section 29. Displacements of the flange 7 therefore do not cause any application of force on the stud bolts 15. Instead of using separate sealing elements 37, 39, sealing beads which act on the inside and/or the outside of the bottom 21 to form a seal could be made on the bottom 21 of the enclosure part 19. As has been shown in practical tests, in the invention the screw connection can be advantageously implemented with relatively small tightening torque. In an alternative embodiment, which is not detailed, screw heads can also be directly used in which the respective head is connected to the threaded bolts. Even if there should be slight expansion between the components which include the enclosure part 19, passages 23, side walls 25, and cover parts 27, this does not affect the effectiveness of the equalization means according to the invention. Nor does each connection, which is to be established, need to be provided with an oblong hole 13.

1. A device for forming a sealed screw connection for connecting a pipe (5) to an outlet (3) for a flow medium which thermally loads the device, in particular for connecting an exhaust manifold (5) to the exhaust outlet (3) of an internal combustion engine, with holes (13) provided in a fixing flange (7) of the pipe (5) for the respective threaded bolts (15) and a sealing arrangement (37, 39) which is located between the flange (7) and the outlet (3), characterized in that there is an enclosure part (19) which encloses the flange (7) on its side facing the outlet (3), leaving at least one passage (23) for the medium, and which forms an at least partial enclosure of the other edge regions (41) of the flange (7), through which regions the threaded bolts (15) extend, that in the enclosure part (19) at least one hole (31) has a diameter which is matched to the threaded bolt (15) associated with it and the holes located in the flange (7) are made as oblong holes (13) which enable movement of the pipe (5) in one displacement direction (17) transversely to the threaded bolts (15), and that there is a sealing element (37, 39) of the sealing arrangement on both sides of the part (21) of the enclosure part (19), which former part faces the outlet (3).

2. The device according to claim 1, characterized in that the flange (7) on the two longitudinal edges (9) which extend along the displacement direction (17) which is dictated by the oblong holes (13), has a sequence of oblong holes (13) and that the enclosure part (19) on its side facing the outlet (3) forms a bottom (21) which continues from longitudinal edge (9) to longitudinal edge (9) of the flange (7), and which is provided with passages (23) for the medium and with holes (31) which are matched to the diameters of the threaded bolts (15).

3. The device according to claim 2, characterized in that the enclosure part (19) is made integral with side walls (25) which are angled off from the bottom (21) and which extend along the longitudinal edges (9) of the flange (7), and with cover parts (27, 29) which extend in the region of the longitudinal edges (9) of the flange (7) on its upper side (41) which faces away from the outlet (3).

4. The device according to claim 3, characterized in that the cover parts (27) which contain a sequence of holes (31) for the threaded bolts (15) extend over the entire length of the enclosure part (19).

5. The device according to claim 4, characterized in that in regions which are located between successive holes (31) the cover parts (27) are provided with spacer surfaces and/or convexities (33) which each form an intermediate space (35) between the upper side (41) of the flange (7) and the cover part (27).

6. The device according to claim 4, characterized in that the cover parts are divided into separate cover sections (29) which are separated by intermediate spaces and that there are holes (31) for the threaded bolts (15) in the cover sections (29).

7. The device according to claim 2, characterized in that the sealing element (39) which is provided between the bottom (21) of the enclosure part (19) and the facing surface of the flange (7) is made to be friction-reducing and/or is provided with friction-reducing means.

8. The device according to claim 3, characterized in that there are friction-reducing configurations and/or friction-reducing means between the upper side (41) of the flange (7) and the cover parts (27, 29) of the enclosure part (19).

9. The device according to claim 1, characterized in that the flange (7) is part of an exhaust manifold (5), which in order to form a common connection for several exhaust outlets (3) distributed in the longitudinal direction has elongated longitudinal edges (9) that contain oblong holes (13), and shorter side edges that connect the longitudinal edges on the end side and that the enclosure part (19) extends over the entire sequence of oblong holes (13) of the flange (7).

10. The device according to claims 2, characterized in that the displacement direction (17), which is dictated by the oblong holes (13), runs along the longitudinal edges (9) of the flange (7).
